(19) United States
(12) Patent Application Publication
(10) Pub. No.: US 2022/0237651 A1
(43) Pub. Date: Jul. 28, 2022

(54) BENEFIT DISTRIBUTION SYSTEM, BENEFIT DISTRIBUTION METHOD, AND BENEFIT DISTRIBUTION PROGRAM

(71) Applicant: DWANGO Co., Ltd., Tokyo (JP)

(72) Inventors: Takashi KOJIMA, Tokyo (JP); Kazuomi NIWA, Tokyo (JP)

(73) Assignee: DWANGO Co., Ltd., Tokyo (JP)

(21) Appl. No.: 17/617,471

(22) PCT Filed: Oct. 13, 2020
(86) PCT No.: PCT/JP2020/038649

§ 371 Date: Dec. 8, 2021

(30) Foreign Application Priority Data
Oct. 31, 2019 (JP) 2019-199166

(51) Int. Cl. G06Q 30/02

(52) U.S. Cl. CPC G06Q 30/0239; G06Q 30/0201

(57) ABSTRACT

A benefit distribution system configured to distribute benefits related to products and services of a specific advertiser comprising: a benefit awarding unit configured to allows a user who watches specific content to acquire a benefit, the benefit being associated with at least a real store or a virtual store in a network making the benefit available; a notification unit configured to notify the user terminal of the user of proximity information indicating the proximity to a store when the user is within a predetermined proximity to a store at which the benefit is available in either real space or virtual space; and a presentation unit configured to presents to the user content information related to the content that triggered acquisition of the benefit when the user uses the benefit at the store

### TECHNICAL FIELD

The present invention relates to a benefit distribution system, a benefit distribution method, and a benefit distribution program.

### BACKGROUND ART

Services that allow content such as movies to be viewed on user terminals distribute advertising along with that content. The advertising is inserted before the start of the content and during the content, and users often can perform an operation to skip the advertising. However, there is a technology in use in which rewards are distributed to user terminals in the form of electronic coupons. A system is described in Patent Document 1 that presents electronic coupons to end users who can redeem these electronic coupons at retail locations.

### PRIOR ART DOCUMENTS

### Patent Documents

Patent Document 1: JP 2003-511797 A

### SUMMARY OF THE INVENTION

### Problem to be Solved by the Invention

Users who wish to view certain content such as movies often do not want to take the time to view advertising that has been inserted into the content and often skip the advertising when allowed to do so. Users find viewing advertising and skipping advertising to be annoying. When users skip advertising, it is difficult for advertisers to obtain the benefits of placing advertising in the content. Also, when content providers insert advertising, they run the risk of users losing interest in viewing their content.

Therefore, it is an object of the present invention to distribute benefits that advertisers, content providers, and users all derive merit from.

### Means for Solving the Problem

One aspect of the present disclosure is a benefit distribution system that distributes rewards related to products and services of a specific advertiser, the benefit distribution system comprising: a benefit awarding unit that allows a user who watches specific content to acquire a benefit, the benefit being associated with at least a real store or a virtual store in a network making the benefit available; a notification unit that notifies the user terminal of the user of proximity information indicating the proximity to a store when the user is within a predetermined proximity to a store at which the benefit is available in either real space or virtual space; and a presentation unit that presents to the user content information related to the content that triggered acquisition of the benefit when the user uses the benefit at the store.

Because benefits can be awarded to users regardless of whether or not the advertising has been viewed, users can be awarded benefits without the stress of actually having to view advertising. Also, because the user is notified when approaching a store where the benefit can be used, the user can be alerted to the opportunity to use the benefit and can be encouraged to enjoy an advertiser's product or service even when the user has not viewed the advertisement. Because the user is made aware of the content that enables the user to obtain a benefit, the user is motivated to view more content from the content provider.

### Effect of the Invention

The present invention is able to distribute benefits that advertisers, content providers, and users all derive merit from.

### BRIEF DESCRIPTION OF THE DRAWINGS

FIG. 1 is a diagram showing an example of the device configuration of the benefit distribution system in an embodiment of the present invention.

FIG. 2 is a diagram showing an example of the hardware configuration related to the benefit distribution system in the embodiment.

FIG. 3 is a block diagram showing an example of the functional configuration of the distribution server related to the embodiment.

FIG. 4 is a diagram showing an example of the functional configuration of a user terminal related to the embodiment.

FIG. 5 is a diagram showing an example of the configuration of a content database.

FIG. 6 is a diagram showing an example of the configuration of an electronic coupon.

FIG. 7 is a diagram showing an example of the configuration of advertising fee management data.

FIG. 8 is a diagram showing an example of a screen displayed on a user terminal that has displayed content information.

FIG. 9 is a flowchart showing an example of operations performed by the benefit distribution system in the embodiment.

FIG. 10 is a flowchart showing an example of operations performed by the user terminal in the embodiment.

FIG. 11 (a) is a diagram showing an example of the configuration of the server program in the embodiment. FIG. 11 (b) is a diagram showing an example of the configuration of the terminal program in the embodiment.

### MODE FOR CARRYING OUT THE INVENTION

An embodiment of the present invention will now be described in detail with reference to the appended drawings. In the description of the drawings, identical or similar elements are denoted by the same reference numbers and redundant description of these elements has been omitted.

In the present embodiment, the benefit distribution system in the disclosure is applied to a system that distributes content. The system that distributes content is a computer system that distributes content to users. This content is provided by a computer or a computer system and is information in a form that is recognizable to people. The electronic data indicating the content is referred to as content data. There are no particular restrictions on the form that this content takes. Content may take the form of video (still images, moving images, etc.), text, audio, music, or a combination of two or more of these forms. There are no particular restrictions on the purpose and venue of the content. The content can be used for a variety of purposes, including entertainment, news, education, medical information, games, chat, commerce, lectures, seminars, or training. Distribution refers to processing in which information is sent to users via a communication network or broadcasting network. In the present disclosure, distribution is a concept that may include broadcasting.

The system for distributing content distributes content to users by sending content data to user terminals. In this example, the content is provided by a distributor. A distributor is a person who wishes to convey information to users. In other words, the distributor is a content distributor.

In the present embodiment, the content is composed at least of video. This content may be moving images or still images. Content consisting of still images can take the form of a website's homepage that the user can scroll down using a scroll bar. Content consisting of still images can also take the form of a slide show containing a plurality of still images.

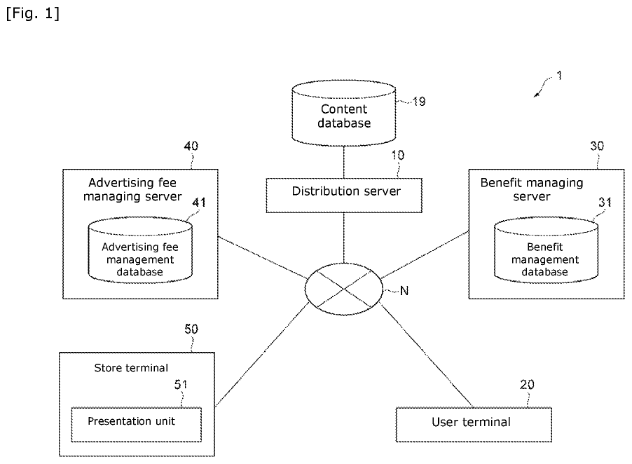

FIG. 1 is a diagram showing an example of the device configuration of the benefit distribution system 1 in the present embodiment. As shown in FIG. 1, the benefit distribution system 1 in the present embodiment includes a distribution server 10, a content database 19, a user terminal 20, a benefit managing server 30, an advertising fee managing server 40, and a store terminal 50. The user terminal 20, benefit managing server 30, advertising fee managing server 40, and store terminal 50 are able to communicate with each other via a network N.

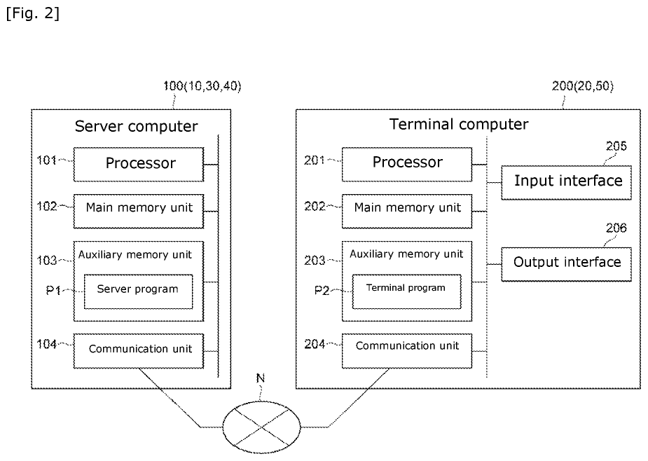

FIG. 2 is a diagram showing an example of the hardware configuration related to the benefit distribution system 1 in the present embodiment. FIG. 2 shows the server computer 100 functioning as the distribution server 10 and the user terminal computer 200 functioning as the user terminal 20. Both the benefit managing server 30 and the advertising fee managing server 40 may be configured using a computer with the same configuration as the server computer 100, and the distribution server 10, the benefit managing server 30, and the advertising fee managing server 40 may be configured as a single server computer 100. In addition, the store terminal 50 may be configured using a computer with the same configuration as the terminal computer 200.

In one example, the server computer 100 has a hardware configuration consisting of a processor 101, a main memory unit 102, an auxiliary memory unit 103, and a communication unit 104.

The processor 101 is an arithmetic unit that executes the operating system and application programs. There are no particular restrictions on the type of processor 101 that is used. Examples of processors include a central processing unit (CPU) and a graphics processing unit (GPU). The processor 101 may also be combined with sensors and dedicated circuits. The dedicated circuit may be a programmable circuit such as a field-programmable gate array (FPGA), or may be some other type of circuit.

The main memory unit 102 is a device that stores the programs used to realize the distribution server 10, the benefit managing server 30, and the advertising fee managing server 40, and that stores calculation results outputted by the processor 101. The main memory unit 102 may be composed of, for example, at least one of a read-only memory (ROM) and random access memory (RAM).

The auxiliary memory unit 103 is usually a device that can store a larger amount of data than the main memory unit 102. The auxiliary memory unit 103 may be composed of a non-volatile storage medium such as a hard disk or a flash memory. The auxiliary memory unit 103 stores the server programs P1 and data used to make the server computer 100 function as the distribution server 10, the benefit managing server 30, or advertising fee managing server 40. In the present embodiment, the benefit distribution program is implemented as a server program P1.

The communication unit 104 is a device used to exchange data with other computers via a communication network N. The communication unit 104 may consist of, for example, a network card or a wireless communication module.

The functional elements of the server are realized by reading the corresponding server programs P1 from the processor 101 or main memory unit 102 and having the processor 101 execute the programs. The server programs P1 contain code for implementing each functional element of the corresponding server. The processor 101 operates the communication unit 104 in accordance with a server program P1 and writes and reads data to and from the main memory unit 102 or the auxiliary memory unit 103. When this processing is performed, each functional element of the corresponding server is realized.

Each server can consist of one or more computers. When a single server uses a plurality of computers, the computers may be connected to each other via a communication network to logically constitute a single server.

In one example, the user terminal computer 200 has a hardware configuration consisting of a processor 201, a main memory unit 202, an auxiliary memory unit 203, a communication unit 204, an input interface 205, and an output interface 206.

The processor 201 is an arithmetic unit that executes the operating system and application programs. The processor 201 can be a CPU or a GPU, but there are no particular restrictions on the type of processor 201 that is used.

The main memory unit 202 is a device that stores programs for realizing the user terminal 20 or the store terminal 50, and stores calculation results outputted by the processor 201. The main memory unit 202 may be composed of, for example, at least one of a ROM and a RAM.

The auxiliary memory unit 203 is usually a device that can store a larger amount of data than the main memory unit 202. The auxiliary memory unit 203 may be composed of a non-volatile storage medium such as a hard disk or a flash memory. The auxiliary memory unit 203 stores the terminal programs P2 and data used to make the terminal computer 200 function as the user terminal 20 or the store terminal 50. For example, the auxiliary memory unit 203 may store data relating to at least one of a virtual object, such as an avatar, and a virtual space.

The communication unit 204 is a device that exchanges data communication with other computers via the communication network N. The communication unit 204 may be composed of, for example, a network card or a wireless communication module.

The input interface 205 is a device that receives data based on operations and user input. For example, the input interface 205 may be composed of at least one of a keyboard, buttons, a pointing device, a microphone, a sensor, and a camera. The keyboard and buttons may be displayed on a touch panel. As there are no particular restrictions on the input interface 205, there are none on the data that is inputted either. For example, the input interface 205 may receive data inputted or selected using a keyboard, buttons, or a pointing device. Alternatively, the input interface 205 may receive voice data inputted using a microphone. Alternatively, the input interface 205 may receive image data (such as video data or still image data) captured using a camera.

The output interface 206 is a device that outputs data processed by the terminal computer 200. For example, the output interface 206 may be composed of at least one of a monitor, a touch panel, an HMD, and a speaker. A display device such as a monitor, a touch panel, and an HMD displays processed data on a screen. A speaker outputs the audio indicated by processed audio data.

The functional elements of the user terminal 20 or store terminal 50 are realized by reading the corresponding terminal program P2 from the processor 201 or main memory unit 202 and having the processor execute the programs. The server programs P2 contain code for implementing each functional element of the user terminal 20 or the store terminal 50. The processor 201 operates the communication unit 204, the input interface 205, or the output interface 206 in accordance with a terminal program P2 and writes and reads data to and from the main memory unit 202 or the auxiliary memory unit 203. When this processing is performed, each functional element of the user terminal 20 or the store terminal 50 is realized.

At least one of the server programs P1 and the terminal programs P2 may be recorded and provided on a tangible recording medium such as a CD-ROM, a DVD-ROM, or a semiconductor memory. Alternatively, at least one of these programs may be provided via a communication network as data signals superimposed on carrier waves. These programs may be provided separately or together.

Referring again to FIG. 1, the distribution server 10 is a computer that distributes content by a predetermined distributor. The distribution server 10 also distributes benefits related to the products and services of a predetermined advertiser.

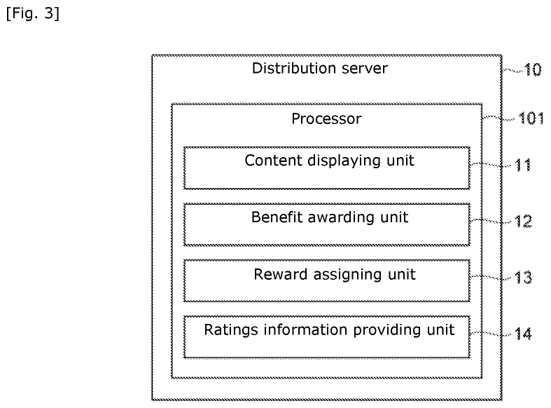

FIG. 3 is a block diagram showing an example of the functional configuration of the distribution server 10. As shown in FIG. 3, the distribution server 10 includes a content displaying unit 11, a benefit awarding unit 12, a reward assigning unit 13, and a ratings information providing unit 14. Each of functional units 11 to 14 is realized by loading a server program P1 into the processor 101 and executing the program. Each of these functional units will be described later.

The user terminal 20 is a computer used by a user. The user terminal 20 has a function that receives and displays content distributed by the distribution server 10. The user terminal 20 may also have the function of detecting its position using, for example, a GPS device (not shown). There are no particular restrictions on the type or configuration of the user terminal 20. For example, the user terminal 20 may be a mobile terminal such as a high-performance mobile phone (smartphone), a tablet terminal, a wearable terminal (for example, a head-mounted display (HMD) or smart glasses), a laptop personal computer, or a mobile phone. Alternatively, the user terminal 20 may be a stationary terminal such as a desktop personal computer.

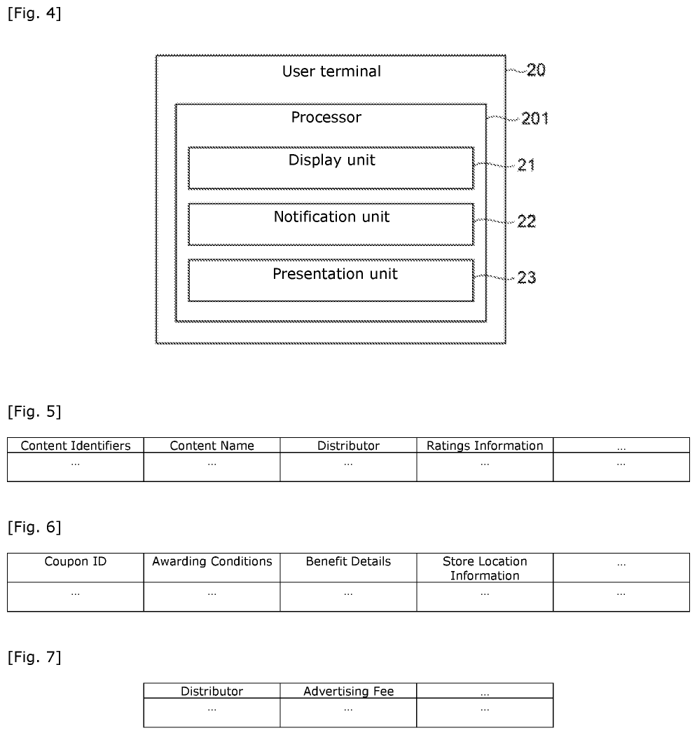

FIG. 4 is a diagram showing an example of the functional configuration of the user terminal 20. As shown in FIG. 4, the user terminal 20 includes a display unit 21, a notification unit 22, and a presentation unit 23. Each of functional units 21 to 23 is realized by loading a terminal program P2 into the processor 201 and executing the program. Each of these functional units will be described later.

The content database 19 is a non-temporary storage medium or storage device for storing content data. The distribution server 10 sends content data read from the content database 19 to the user terminal 20. FIG. 5 is a diagram showing an example of the configuration of content information in the content database 19. The content database 19 stores the content identifier, names, distributor, and ratings information shown in FIG. 5 associated with content data.

The content identifier is information used to identify unique content. The content name is the name of the content. The distributor can be, for example, the creator of the content. A distributor may distribute its own content to users via a content provider. Ratings information indicates a positive or negative rating of the content. For example, when a user has viewed inputted content and has pressed a button on the user terminal 20 indicating a positive rating, the information indicating the number of positive ratings is increased by 1 and stored as ratings information.

The benefit managing server 30 is a computer that manages coupons, which is a form that benefits can take in the present disclosure. The benefit managing server 30 includes a benefit management database 31. The benefit management database 31 is a non-temporary storage medium or storage device that stores information related to coupons. FIG. 6 is a diagram showing an example of coupon information stored in the benefit management database 31. Coupon information includes a coupon ID, awarding conditions, benefit content, and store location information.

The coupon ID is the identifier used to identify each coupon. The awarding conditions indicate the conditions under which the benefit is awarded. Examples of awarding conditions include “the user has viewed specific content” and “the user has viewed all related content.”

Benefit content is information indicating the benefit that a user can enjoy with the coupon. For example, it can be information indicating that a predetermined product can be purchased at a predetermined store under advantageous conditions (such as a discount).

The store location information can be, for example, location information indicating the location of a store related to the benefit. When the benefit is related to the purchase of a product at a virtual store on a network, the store location information can be information indicating the location of a virtual store in network space, for example, a URL. In other words, a coupon is at least associated with a real store or a virtual store where the benefit associated with the coupon is available.

The advertising fee managing server 40 is a computer that manages advertising fee information related to rewards generated by content distributors. The advertising fee managing server 40 includes an advertising fee management database 41. The advertising fee management database 41 is a non-temporary storage medium or storage device for storing advertising fee information.

FIG. 7 is a diagram showing an example of the configuration of advertising fee information. As shown in FIG. 7, the advertising fee information includes information such as distributors and advertising fees. Distributor indicates the distributor who is to receive an advertising fee as a reward. The advertising fee indicates the amount generated by the distributor.

The store terminal 50 is a computer provided in a real store. The store terminal 50 may be, for example, a register terminal in a physical store. The store terminal 50 in the present embodiment includes a presentation unit 51. The presentation unit 51, as described later, is a display means for presenting content information to a user when a coupon is used.

Referring again to FIG. 3, each functional unit in the distribution server 10 will now be described. The content displaying unit 11 is used to display content on a user terminal 20. For example, the content displaying unit 11 displays content for a user by retrieving content from the content database 19 in response to a request from the user terminal 20 and sending the retrieved content to the user terminal 20.

When ratings information that indicates positive ratings for the content has been associated with the content, the content displaying unit 11 sends the ratings information along with the content to the user terminal 20 so that ratings information is displayed on the user terminal 20 along with the content.

The benefit awarding unit 12 allows a user who has viewed specific content to acquire a benefit. Specifically, when a coupon has been associated with specific content and viewing the content has been set as a condition for receiving the coupon, the benefit awarding unit 12 sends coupon information to the user terminal 20 when the specific content has been viewed on the user terminal 20 by the user.

Generally, advertising is played before or during playback of the content, and the user can obtain a coupon that allows the user to enjoy a benefit from the advertiser at a store on condition that the advertising is viewed. However, in the present embodiment, the benefit is provided to the user regardless of whether or not the advertising is viewed, and the user can receive the benefit without the stress of having to view the advertising.

When the coupon information indicates that a condition for receiving the benefit is “viewing all related content,” the benefit awarding unit 12 sends the coupon information to a user terminal 20 when all of the related content has been viewed on the user terminal 20.

When the content is viewed on the user terminal 20 using a specific application or browser for viewing the content, the application or browser has information that identifies the user such as an account. The benefit awarding unit 12 acquires the information identifying the user from the application or browser, and transmits the coupon information to the user. The user may be alerted to reception of coupon information on the user terminal 20 but does not have to be alerted to receipt of the coupon.

The present embodiment is configured so that the user acquires a coupon when coupon information is sent to a user terminal 20. However, the present invention is not limited to this configuration. For example, when specific content has been viewed by a user on a user terminal 20, the user may acquire a coupon by having the distribution server 10 or benefit managing server 30 generate and store information associating coupon information with the identifier for the user terminal 20.

In order to simplify the description, the reward assigning unit 13 and the ratings information providing unit 14 will be described later. Here, the various functional units of the user terminal 20 will be described with reference to FIG. 4.

The display unit 21 displays content. Specifically, the display unit 21 displays content sent by the content displaying unit 11 to the distribution server 10 on a display means such as a display provided in the user terminal 20.

When ratings information is associated with the content and the ratings information has been sent by the content displaying unit 11 along with the content as described later, the display unit 21 displays the ratings information along with the content on a display means such as a display.

The notification unit 22 notifies the user of proximity information indicating the proximity to a store where the coupon can be used when the user is within a predetermined proximity to the store in either real space or virtual space.

Specifically, when the coupon can be used at a store in real space, the notification unit 22 acquires position information indicating the current position of the user terminal from, for example, a GPS device (not shown) in the user terminal 20. The notification unit 22 references location information on stores at which the coupon can be used in the coupon information, and notifies the user of proximity information indicating that a store where the coupon can be used is nearby when the current position of the user terminal 20 is within a predetermined distance of the position information on the store. The user may be notified by outputting an alarm or a voice message on the user terminal 20, causing the user terminal 20 to vibrate, or displaying the message on the display. By notifying the user of proximity information, the user can be alerted of an opportunity to use the coupon.

When the coupon can be used at a virtual store (e-commerce site) in network space, the notification unit 22 notifies the user of proximity information when the position accessed by the user terminal in the network space is to a certain extent close to the virtual store in the network. Specifically, the notification unit 22 notifies the user of proximity information when the user terminal 20 has accessed the site of a virtual store and the accessed URL matches the URL indicating the location of the virtual store in network space to a certain extent.

In the present embodiment, the store at which the coupon can be used is either a store in real space or a virtual store in network space, but the present invention is not limited to these examples. The store does not have to have a store-like appearance, and the concept here includes locations, organizations, and sites where products and services are provided. Also, the product or service provided by the store may be free. The product or service provided by the store includes the downloading of content from a site via a network.

When a user uses a coupon at a store, the presentation unit 23 presents to the user content information related to the content where the opportunity to obtain a coupon occurred. As mentioned above, when the notification unit 22 notifies the user of proximity information, the user becomes aware of an opportunity to use a coupon. The user can then use the coupon at a store in real space or a virtual store based on this notification. The use of the coupon at a store allows the user to enjoy the favorable conditions indicated by the coupon, for example, the purchase of a specific product on favorable conditions (such as a discount).

Because the conditions under which the coupon was awarded in the coupon information includes information related to the content where the opportunity to obtain the coupon occurred, the presentation unit 23 can reference the content database 19 to acquire content information such as the name, distributor, and provider of the content. Content information such as the name, distributor, and provider of the content is included in the coupon information and sent from the distribution server 10 to the user terminal 20. In this way, the presentation unit 23 can acquire content information such as the name, distributor, and provider of the content from the coupon information.

The presentation unit 23 then presents content information including any of the name, distributor, and provider of the content to the user as those who provided the opportunity to use the coupon. Specifically, the presentation unit 23 displays the content information on the display of the user terminal 20.

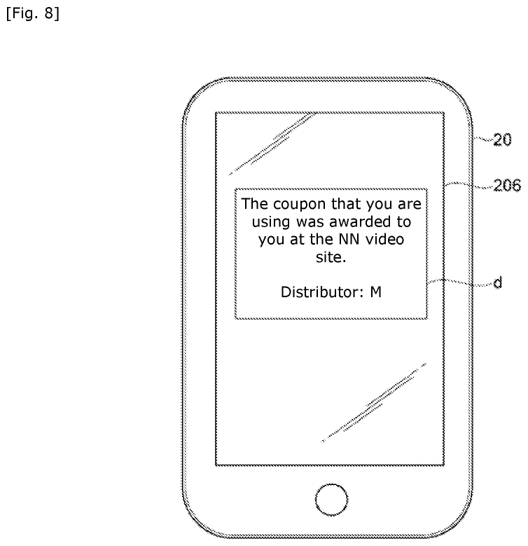

FIG. 8 is a diagram showing an example of a screen displayed on a user terminal 20 that has displayed content information. As shown in FIG. 8, the presentation unit 23 displays content information d on the display in the user terminal 20 that is one form the output interface 206 can take. In the example shown in FIG. 8, the content information includes the message “The coupon that you are using was awarded to you at the NN video site. Distributor: M.” In the example shown in FIG. 8, the content information indicates that the distributor is M and that the content provider is the NN video site. By presenting content information in this way, the user can be reminded of the name, distributor, and provider of the content that afforded the user the opportunity to acquire the coupon.

The presentation unit 23 may display the content information on a display device installed at the real store and configured so as to be able to communicate with the benefit distribution system 1. Specifically, the presentation unit 23 may display the content information on a presentation unit 51 in a store terminal 50. Because the store terminal 50 can be a register terminal in a real store, the content information can be displayed on a presentation unit 51 when the coupon is used to remind the user of the name, distributor, and provider of the content that afforded the user the opportunity to acquire the coupon.

Description of the functional units in the distribution server 10 will now continue by referring again to FIG. 3. When a user uses a coupon at a store, the reward assigning unit 13 assigns a reward from the store to the distributor of the content, associates reward information on the issued reward with the distributor, and stores the associated information. In the present embodiment, the reward to distributors from stores is an advertising fee.

Specifically, when a user has used a coupon at a real or virtual store, this information is sent from the store terminal 50 or user terminal 20 to the distribution server 10. When the reward assigning unit 13 has received information on the use of the coupon, it generates a preset advertising fee for use of the coupon and, as shown in FIG. 7, associates the generated advertising fee with the distributor of the content affording the opportunity for the coupon to be distributed, and stores the associated information in the advertising fee management database 41. In this way, when a coupon related to a product or service from an advertiser is used at a store, a reward can be generated from the advertiser to the distributor in the form of an advertising fee, and advertising costs that provide no return on investment to advertisers can be avoided.

In the present embodiment, the reward assigning unit 13 generates a specific advertising fee and assigns this to the distributor of the content that afforded the user the opportunity to use the coupon at a real or virtual store. However, the present invention is not limited to this embodiment. For example, the reward assigning unit 13 can generate a specific advertising fee and assigns this to the distributor of the content when a user terminal 20 is detected within a given proximity to a store in real space or a virtual store in network space or when notification of proximity information indicating proximity to the store has been given.

When a user uses a coupon at a store, the ratings information providing unit 14 associates ratings information indicating positive ratings for the content with the content. This ratings information is information indicating positive or negative ratings for content. In a typical embodiment of the provision of ratings information, when a user who has viewed content presses a button on the user terminal 20 indicating a positive rating, the information indicating the number of positive ratings is increased by one and stored as the ratings information. Ratings information indicating the number of positive and/or negative ratings is then displayed along with the content on the screen while the content is being viewed.

In the present embodiment, when a user uses a coupon at a store, information indicating that the coupon has been used is sent from the user terminal 20 or a store terminal 50 to the distribution server 10. When the ratings information providing unit 14 receives information that a coupon has been used, it increases the positive ratings for the content that afforded the user the opportunity to use the coupon by a predetermined number (for example, 1), assigns the increased rating information to the content, and stores this as the ratings information as shown in FIG. 5. When the content is being viewed, the content displaying unit 11 displays the ratings information associated with the content. By assigning and displaying ratings information in this way, an intangible reward can be provided to the distributor of the coupon related to a product or service from the advertiser.

In the present embodiment, the ratings information providing unit 14 associates ratings information indicating positive ratings for content with the content that afforded the opportunity for a coupon to be used at a real or virtual store. However, the present invention is not limited to this embodiment. For example, the ratings information providing unit 14 can associate ratings information indicating positive ratings for content when a user terminal 20 is detected within a given proximity to a store in real space or a virtual store in network space or when notification of proximity information indicating proximity to the store has been given.

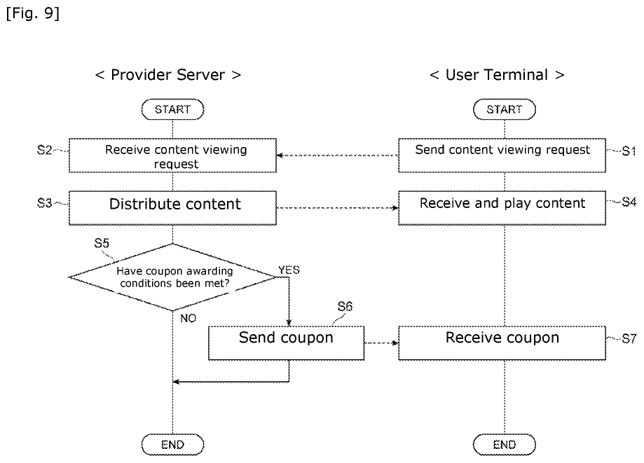

The operations performed by the benefit distribution system 1 in the present embodiment will now be explained with reference to FIG. 9. FIG. 9 is a flowchart showing the steps performed by the benefit distribution system 1 when distributing a coupon.

In step S1, the user terminal 20 sends a content viewing request to the distribution server 10. In step S2, the content displaying unit 11 in the distribution server 10 receives the content viewing request.

In step S3, the content displaying unit 11 responds to the viewing request from the user terminal 20 by retrieving the content from the content database 19 and distributing the retrieved content to the user terminal 20.

In step S4, the display unit 21 in the user terminal 20 receives the content and plays back and displays the received content on a display means such as a display.

In step S5, the benefit awarding unit 12 in the distribution server 10 determines whether or not viewing of the content on the user terminal 20 in steps S1 to S4 meets the conditions for receiving a coupon. When the coupon receiving conditions have been met, the benefit awarding unit 12 sends a coupon to the user terminal 20 in step S6.

When the coupon receiving conditions have not been met, the process performed to distribute coupons is ended.

In step S7, the user terminal 20 receives the coupon sent by the benefit awarding unit 12. Because a coupon is awarded to the user regardless of whether or not the advertising has been viewed, the user can be awarded a coupon without the stress of actually having to view the advertising.

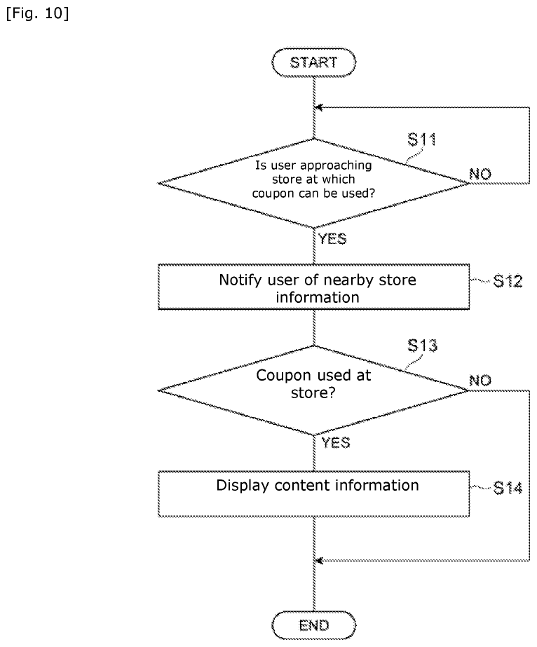

FIG. 10 is a flowchart showing an example of processing performed in a benefit distribution method embodied by a benefit distribution system 1 using coupons.

In step S11, the notification unit 22 determines whether or not the user is near a store at which the coupon can be used. When it has been determined that the user is near a store at which the coupon can be used, the notification unit 22 sends proximity information to the user terminal 20 in step S12 which indicates that the user is in the proximity to a store at which the coupon can be used. In this way, the user can be alerted to the opportunity to use the coupon and can be encouraged to enjoy a product or service from the advertiser at the store whether or not the advertising has been viewed by the user.

Next, in step S13, the presentation unit 23 determines whether or not the user has used the coupon at the target store. When it has been determined that the coupon has been used, the presentation unit 23 in step S14 presents content information to the user which is related to the content that afforded the user the opportunity of receiving the coupon. Because the user is reminded of the content that enabled the coupon to be received, the user can be encouraged to view more content from the distributor of the content.

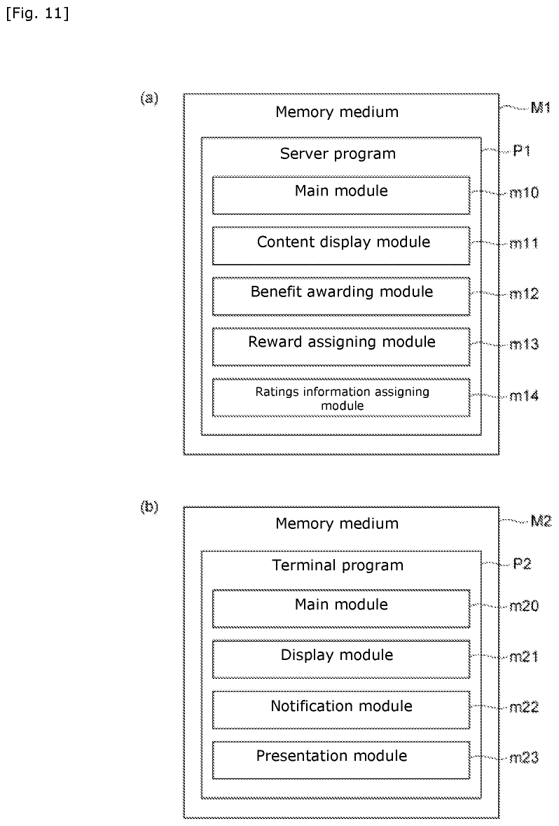

The benefit distributing programs used to get computers to function as a benefit distribution system 1, including a server program and a terminal program, will now be explained with reference to FIG. 11. The server program P1 shown in FIG. 11 (a) is the program that gets a computer to function as the distribution server 10, and this program includes a main module m10, a content display module m11, a benefit awarding module m12, a reward assigning module m13, and a ratings information providing module m14.

The main module m10 is the portion that controls all of the benefit distribution processing in the distribution server 10. When the content display module m11, benefit awarding module m12, reward assigning module m13, and ratings information providing module m14 are executed by the processor, the functions of the content displaying unit 11, the benefit awarding unit 12, the reward assigning unit 13, and the ratings information providing unit 14 are realized by the distribution server 10 in FIG. 3.

The terminal program P2 shown in FIG. 11 (b) is the program that gets a computer to function as the user terminal 20, and this program includes a main module m20, a display module m21, a notification module m22, and a presentation module m23.

The main module m20 is the portion that controls all of the benefit distribution processing in the user terminal 20. When the display module m21, the notification module m22, and the presentation module m23 are executed by the processor, the functions of the display unit 21, the notification unit 22, and the presentation unit 23 are realized by the user terminal 20 in FIG. 4.

The server program P1 and the terminal program P2 can be provided on storage media M1, M2 such as a CD-ROM, a DVD-ROM, or a semiconductor memory. The server program P1 can alternatively be provided over a communication network as computer data signals superimposed on carrier waves.

Because benefits can be awarded to users by the benefit distribution system 1, benefit distribution method, and benefit distributing programs P1, P2 in the embodiments described above regardless of whether or not the advertising has been viewed, users can receive benefits without the stress of actually having to view advertising. Because user terminals can be notified when a store at which the coupon can be used is nearby, users can be reminded of the opportunity to use the coupon and can be encouraged to enjoy a product or service from the advertiser whether or not the user has viewed the advertising. Also, because the user can be reminded of the content that afforded the user the opportunity to receive a benefit, the user can be motivated to view more content from the content provider.

One aspect of the present disclosure is a benefit distribution method executed by a benefit distribution method that distributes benefits related to products and services of a specific advertiser, the benefit distribution method comprising: a benefit awarding step of allowing a user who watches specific content to acquire a benefit, the benefit being associated with at least a real store or a virtual store in a network making the benefit available; a notification step of notifying the user terminal of the user of proximity information indicating the proximity to a store when the user is within a predetermined proximity to a store at which the benefit is available in either real space or virtual space; and a presentation step of presenting to the user content information related to the content that triggered acquisition of the benefit when the user uses the benefit at the store.

Another aspect of the present disclosure is a benefit distribution program causing a computer to function as a benefit distribution system that distributes benefits related to products and services of a specific advertiser, the benefit distribution program causing the computer to realize: a benefit awarding function of allowing a user who watches specific content to acquire a benefit, the benefit being associated with at least a real store or a virtual store in a network making the benefit available; a notification function of notifying the user terminal of the user of proximity information indicating the proximity to a store when the user is within a predetermined proximity to a store at which the benefit is available in either real space or virtual space; and a presentation function of presenting to the user content information related to the content that triggered acquisition of the benefit when the user uses the benefit at the store.

Because benefits can be awarded to users by these aspects of the present disclosure regardless of whether or not the advertising has been viewed, users can receive benefits without the stress of actually having to view advertising. Because user terminals can be notified when a store at which the coupon can be used is nearby, users can be reminded of the opportunity to use the coupon and can be encouraged to enjoy a product or service from the advertiser whether or not the user has viewed the advertising. Also, because the user can be reminded of the content that afforded the user the opportunity to receive a benefit, the user can be motivated to view more content from the content provider.

In a benefit distribution system according to another aspect of the present disclosure, the benefit can be used at a real store, and the notification unit sends the proximity information when the position of the user terminal is within a predetermined distance of the store.

Because the user is notified in this aspect of the present disclosure when approaching a store where the benefit can be used, the user can be encouraged to use the benefit.

In a benefit distribution system according to another aspect of the present disclosure, the presentation unit displays the content information on a display device installed at the real store and configured so as to be able to communicate with the benefit distribution system.

Because content information is displayed on a display terminal at a real store in this aspect of the present disclosure, the user can be reminded of the content and distributor that afforded the user the opportunity to receive the benefit.

In a benefit distribution system according to another aspect of the present disclosure, the benefit can be used at a virtual store in network space, and the notification unit sends the proximity information when the position accessed by the user terminal in the network space is close to the store in the network to a certain extent.

Because the user can be notified in this aspect of the present disclosure while, for example, browsing the web, that a virtual store such as an e-commerce site at which the benefit can be used is nearby, the user can be encouraged to use the benefit.

In a benefit distribution system according to another aspect of the present disclosure, the presentation unit displays the content information on the user terminal.

Because content information is displayed on the user terminal in this aspect of the present disclosure, the user can be reminded of the content and distributor that afforded the user the opportunity to receive the benefit.

In a benefit distribution system according to another aspect of the present disclosure, the benefit awarding unit awards the benefit to the user when the user has viewed all related content.

In this aspect of the present disclosure, when the benefit is used by the user, the user can be reminded that the benefit was obtained because all of the related content was viewed. Therefore, the user can be motivated to view all related content distributed by the distributor of certain content.

In a benefit distribution system according to another aspect of the present disclosure, the benefit awarding unit awards the benefit to the user by sending the benefit to the user terminal.

In this aspect of the present disclosure, the user can make sure the benefit has been received and information related to the benefit can be referenced on the user terminal.

A benefit distribution system according to another aspect of the present disclosure further comprises a reward assigning unit that issues a reward from the store to the distributor of the content when the user has used the benefit at the store, associates reward information on the issued reward with the distributor, and stores the associated information.

In this aspect of the present disclosure, when a coupon related to a product or service from an advertiser is used at a store, a reward can be generated from the advertiser to the distributor in the form of an advertising fee, and advertising costs that provide no return on investment to advertisers can be avoided.

A benefit distribution system according to another aspect of the present disclosure further comprises a ratings information providing unit that associates ratings information indicating a positive rating of the content with the content when the user uses the benefit at the store, and a content displaying unit that displays the ratings information along with the content when the content is viewed.

In this aspect of the present disclosure, ratings information indicating positive ratings is associated with the content and the ratings information is provided to users when the content is being viewed. By assigning and displaying ratings information in this way, an intangible reward can be provided to the distributor of the coupon related to a product or service from the advertiser.

In a benefit distribution system according to another aspect of the present disclosure, the content information includes at least one of the name of the content, the distributor who is the creator of the content, and the content provider who is the business provider of the content.

In this aspect of the present disclosure, the user can be reminded of at least one of the name of the content, the distributor who is the creator of the content, and the content who is the business provider of the content who afforded the user the opportunity to receive a benefit.

The present invention was described in detail above with reference to embodiments. However, the present invention is not limited to these embodiments. Numerous modifications are possible without departing from the scope and spirit of the present invention.

The configurations of the internal components of the benefit distribution system are not limited to those in the embodiments, and may be designed according to any policy. For example, the benefit distribution system may be realized using a single server having the functions of the distribution server 10, the content database 19, the benefit managing server 30, and the advertising fee managing server 40. Alternatively, the benefit distribution system may be configured to include many different types of servers. There are no restrictions on where each of the databases is installed. For example, the content database 19 may be installed in a computer system separate from the benefit distribution system 1.

Also, the devices composed of functional units 11 to 14 and functional units 21 to 22 (server and terminal) are not limited to the examples in the embodiment. The functional units constituted by the distribution server 10 in the embodiment may be constituted by the user terminal 20, and the functional units constituted by the user terminal 20 may be constituted by the distribution server 10.

In the disclosure, the expression “at least one processor performs the first step, the second step, . . . the nth step” and all corresponding expressions include situations in which the executing object (that is, the processor) of n steps from the first step to the nth step changes in the middle of the processing operation. In other words, this expression includes situations in which all n steps are performed by the same processor and situations in which the processor is changed at any time during execution of the n steps.

The order in which the steps are executed by at least one processor is not limited to the example in the embodiment. For example, some of the steps (processes) may be eliminated and each step may be executed in a different order. Also, two or more of the steps may be combined, and some of the steps may be modified or deleted. Other steps may be executed in addition to each of these steps as well.

### KEY TO THE DRAWINGS

1: Benefit distribution system
10: Distribution server
11: Content displaying unit
12: Benefit awarding unit
13: Reward assigning unit
14: Ratings information providing unit
19: Content database
20: User terminal
21: Display unit
22: Notification unit
23: Presentation unit
30: Benefit managing server
31: Benefit management database
40: Advertising fee managing server
41: Advertising fee management database
50: Store terminal
51: Presentation unit
d: Content information
M1, M2: Storage medium
m10: Main module
m11: Content display module
m12: Benefit awarding module
m13: Reward assigning module
m14: Ratings information assigning module
m20: Main module
m21: Display module
m22: Notification module
m23: Presentation module
N: Network
P1: Server program (benefit distribution program)
P2: Terminal program (benefit distribution program)

1. A benefit distribution system configured to distributes benefits related to products and services of a specific advertiser, the benefit distribution system comprising:
a benefit awarding unit configured to allows a user who watches specific content to acquire a benefit, the benefit being associated with at least a real store or a virtual store in a network making the benefit available;
a notification unit configured to notify the user terminal of the user of proximity information indicating the proximity to a store when the user is within a predetermined proximity to a store at which the benefit is available in either real space or virtual space; and
a presentation unit configured to presents to the user content information related to the content that triggered acquisition of the benefit when the user uses the benefit at the store.

2. A benefit distribution system according to claim 1, wherein the benefit can be used at a real store, and
the notification unit is configured to sends the proximity information when the position of the user terminal is within a predetermined distance of the store.

3. A benefit distribution system according to claim 2, wherein the presentation unit is configured to displays the content information on a display device installed at the real store and configured to communicate with the benefit distribution system.

4. A benefit distribution system according to claim 1, wherein the benefit can be used at a virtual store in network space, and
the notification unit is configured to sends the proximity information when the position accessed by the user terminal in the network space is within in a predetermined proximity to the virtual store in the network.

5. A benefit distribution system according to claim 1, wherein the presentation unit is configured to displays the content information on the user terminal.

6. A benefit distribution system according to claim 1, wherein the benefit awarding unit is configured to awards the benefit to the user when the user has viewed all related content.

7. A benefit distribution system according to claim 1, wherein the benefit awarding unit is configured to awards the benefit to the user by sending the benefit to the user terminal.

8. A benefit distribution system according to claim 1, further comprising a reward assigning unit configured to issues a reward from the store to the distributor of the content when the user has used the benefit at the store, associates reward information on the issued reward with the distributor, and stores the associated information.

9. A benefit distribution system according to claim 1, further comprising a ratings information providing unit configured to associates ratings information indicate a positive rating of the content with the content when the user uses the reward at the store, and
a content displaying unit configured to displays the ratings information along with the content when the content is viewed.

10. A benefit distribution system according to claim 1, wherein the content information includes at least one of the name of the content, the distributor who is the creator of the content, and the content provider who is the business provider of the content.

11. A benefit distribution method comprising:
allowing a user who watches specific content to acquire a benefit, the benefit being associated with at least a real store or a virtual store in a network making the benefit available;
notifying a user terminal of the user of proximity information indicating the proximity to a store when the user is within a predetermined proximity to a store at which the benefit is available in either real space or virtual space; and
presenting to the user content information related to the content that triggered acquisition of the benefit when the user uses the benefit at the store.

12. A benefit distribution program causing a computer to function as a benefit distribution system that distributes benefits related to products and services of a specific advertiser, the benefit distribution program causing the computer to:
allow a user who watches specific content to acquire a benefit, the benefit being associated with at least a real store or a virtual store in a network making the benefit available;
notify a user terminal of the user of proximity information indicating the proximity to a store when the user is within a predetermined proximity to a store at which the benefit is available in either real space or virtual space; and
present to the user content information related to the content that triggered acquisition of the benefit when the user uses the benefit at the store.
